(19) United States
(12) Patent Application Publication
(10) Pub. No.: US 2024/0262246 A1
(43) Pub. Date: Aug. 8, 2024

(54) CONTROL APPARATUS AND VEHICLE

(71) Applicant: ISUZU MOTORS LIMITED, Yokohama-shi (JP)

(72) Inventor: Takuya KIKUCHI, Fujisawa-shi (JP)

(21) Appl. No.: 18/425,911

(22) Filed: Jan. 29, 2024

(30) Foreign Application Priority Data
Feb. 6, 2023 (JP) 2023-016029

(51) Int. Cl. B60L 58/18; B60L 53/14; B60L 53/62; H02J 7/00

(52) U.S. Cl. CPC B60L 58/18; B60L 53/14; B60L 53/62; H02J 7/0063

(57) ABSTRACT

A control apparatus is for a plurality of batteries included in a vehicle and connected in parallel and includes: an acquisition section acquiring each state of charge of the plurality of batteries; and a control section determining, among the plurality of batteries, one or more batteries to be discharged, which supply power to an external load for driving the vehicle, and one or more batteries to be charged, which are charged by an external power supply provided outside the vehicle. The control section determines the one or more batteries to be discharged from the plurality of batteries except for a low-remaining-amount battery which is, among the plurality of batteries, a battery in which the state of charge is equal to or less than a predetermined threshold, and determines the one or more batteries to be charged from the plurality of batteries including the low-remaining-amount battery.

### CROSS REFERENCE TO RELATED APPLICATIONS

The present application is based on a Japanese Patent Application (Japanese Patent Application No. 2023-016029), filed on Feb. 6, 2023, the entire content of which is incorporated herein by reference.

### TECHNICAL FIELD

The present disclosure relates to a control apparatus and a vehicle.

### BACKGROUND ART

There is known an electric vehicle (EV) in which a plurality of batteries connected in parallel, an external load such as a motor for vehicle travel, and an electric power system for supplying power from each of the plurality of batteries to the external load are mounted.

For example, Japanese Patent Application Laid-Open No. 2018-057228 (Patent Literature 1) discloses a control apparatus of a vehicle in which the control apparatus detects each state of charge (SOC) of a plurality of batteries connected in parallel, and controls charging/discharging of the plurality of batteries based on the detected SOCs.

Incidentally, a problem is that in a case where a battery with a low SOC among a plurality of batteries connected in parallel is connected to an external load, the battery may be discharged at or more than a design value.

### SUMMARY

An object of the present disclosure is to provide a control apparatus and a vehicle each capable of causing a battery with a low SOC among a plurality of batteries connected in parallel not to be discharged at or more than a design value.

In order to achieve the above-mentioned object, a control apparatus in the present disclosure is a control apparatus for a plurality of batteries which is included in a vehicle and is connected in parallel. The control apparatus includes: an acquisition section that acquires each state of charge of the plurality of batteries; and a control section that determines, among the plurality of batteries, one or more batteries to be discharged and one or more batteries to be charged, where the one or more batteries to be discharged supply power to an external load for driving the vehicle and the one or more batteries to be charged are charged by an external power supply provided outside the vehicle. The control section determines the one or more batteries to be discharged from the plurality of batteries except for a low-remaining-amount battery which is, among the plurality of batteries, a battery in which the state of charge is equal to or less than a predetermined threshold, and determines the one or more batteries to be charged from the plurality of batteries including the low-remaining-amount battery.

A vehicle in the present disclosure includes: the control apparatus described above; and the plurality of batteries described above.

### Advantageous Effects of Invention

According to the present disclosure, it is possible to cause a battery with a low SOC among a plurality of batteries connected in parallel not to be discharged at or more than a design value.

### BRIEF DESCRIPTION OF DRAWINGS

FIG. 1 illustrates an example of an electric power system of an electric vehicle in an embodiment of the present disclosure;

FIG. 2 functionally illustrates an example of a control apparatus in the electric power system in the present embodiment; and

FIG. 3 is a flowchart illustrating an exemplary operation of the control apparatus in the present embodiment.

### DESCRIPTION OF EMBODIMENTS

Hereinafter, an embodiment of the present disclosure will be described with reference to the accompanying drawings.

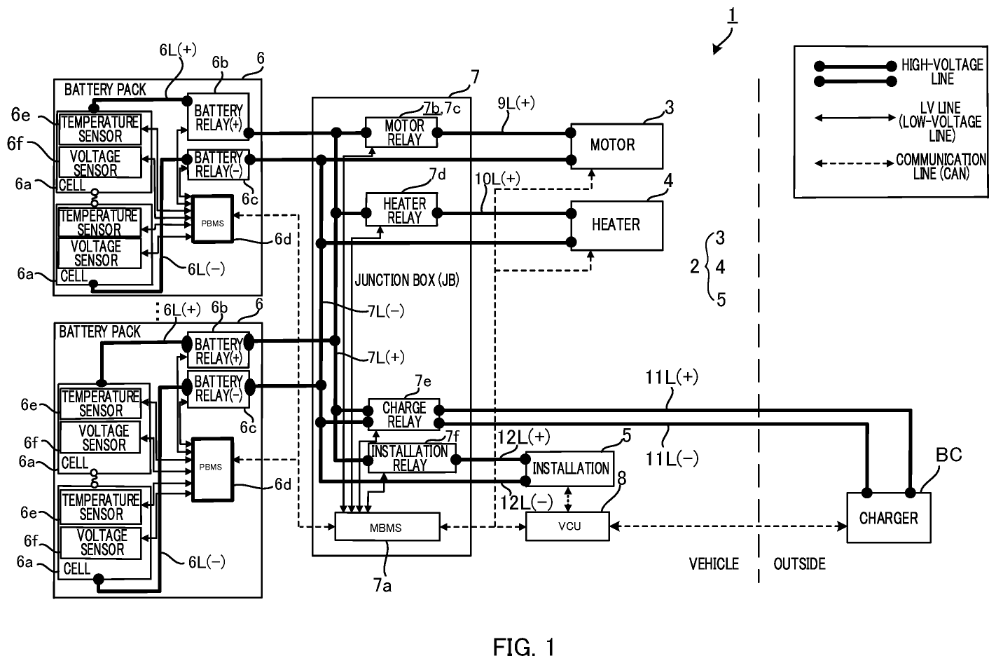

FIG. 1 illustrates an example of electric power system 1 of an electric vehicle (EV) in an embodiment of the present disclosure. Note that, in the following description, a case where the present disclosure is applied to a commercial vehicle such as a truck or a bus will be described, but the present disclosure is not limited thereto and may be applied to a vehicle such as a passenger car.

As illustrated in FIG. 1, external load 2 including motor 3, heater 4 and installation 5, for example; a plurality of battery packs 6; and junction box (JB) 7; and vehicle control unit (VCU) 8 are disposed in electric power system 1. Further, FIG. 1 illustrates charger BC disposed outside the EV. Note that, one or a plurality of battery packs 6 corresponds to the “battery/batteries” in the present disclosure. Connection of charger BC to electric power system 1 allows power to be supplied to the batteries via junction box 7. Further, charging to the battery is released by detaching charger BC from electric power system 1. In the following description, charger BC may be referred to as an “external power supply”. Further, the power supplied from charger BC may be referred to as “external power”.

Motor 3 is a motor for travel, which is driven by power being supplied from battery packs 6 to motor 3.

Heater 4 is a heater which heats battery packs 6 themselves by power being supplied from battery packs 6 to heater 4.

Installation 5 is an apparatus which is mounted in the EV and operates by power being supplied from battery packs 6 to installation 5. Installation 5 encompasses, for example, a loading platform lifting apparatus, a refrigerator, and a freezer.

Each of the plurality of battery packs 6 has the same configuration, and thus, one battery pack 6 among the plurality of battery packs 6 will be described as a representative. Battery pack 6 includes a plurality of cells 6a, battery relay(+) 6b, battery relay(−) 6c, and, battery pack management system (PBMS) 6d.

One terminal of battery relay(+) 6b is connected to the positive terminal of cell 6a via high-voltage line 6L(+). The other terminal of battery relay(+) 6b is connected to high-voltage line 7L(+). One terminal of battery relay(−) 6c is connected to the negative terminal of cell 6a via high-voltage line 6L(−). The other terminal of battery relay(−) 6c is connected to high-voltage line 7L(−).

Cell 6a includes temperature sensor 6e and voltage sensor 6f. Temperature sensor 6e detects the cell temperature. Temperature sensor 6e outputs a detection result (cell temperature) to PBMS 6d. Voltage sensor 6f detects the cell voltage. Voltage sensor 6f outputs a detection result (cell voltage) to PBMS 6d.

Based on both the inputted cell temperatures and the inputted cell voltages, PBMS 6d controls battery relay(+) 6b such that battery relay(+) 6b performs connection/disconnection between high-voltage line 6L(+) and high-voltage line 7L(+), and controls battery relay(−) 6c such that battery relay(−) 6c performs connection/disconnection between high-voltage line 6L(−) and high-voltage line 7L(−).

For example, PBMS 6d calculates, based on the open circuit voltage (OCV) and the cell temperatures in battery pack 6, the SOC by referring to a curve that represents the relationship between the SOC (state of charge) and the OCV, which is set for each cell temperature.

Junction box (JB) 7 is disposed between battery pack 6 and external load 2 as well as charger BC. JB 7 includes master battery management system (MBMS) 7a and relay circuit 7b.

Master battery management system (MBMS) 7a and PBMS 6d are connected via a communication line (CAN). MBMS 7a acquires the state of battery pack 6 (for example, cell temperatures, cell voltages, and SOCs) from PBMS 6d each time a fixed period of time has elapsed. MBMS 7a transmits each control signal of battery relay(+) 6b and battery relay(−) 6c to PBMS 6d.

MBMS 7a controls relay circuit 7b based on the acquired state of battery pack 6.

Relay circuit 7b includes motor relay 7c, heater relay 7d, charge relay 7e, and installation relay 7f.

One terminal of motor relay 7c is connected to high-voltage line 7L(+). The other terminal of motor relay 7c is connected to motor 3 via high-voltage line 9L(+) and an inverter (not illustrated). High-voltage line 7L(−) is connected to motor 3 via an inverter. MBMS 7a controls motor relay 7c such that motor relay 7c performs connection/disconnection between high-voltage line 7L(+) and high-voltage line 9L(+).

One terminal of heater relay 7d is connected to high-voltage line 7L(+). The other terminal of heater relay 7d is connected to heater 4 via high-voltage line 10L(+). High-voltage line 7L(−) is connected to heater 4. MBMS 7a controls heater relay 7d based on the state of battery pack 6 such that heater relay 7d performs connection/disconnection between high-voltage line 7L(+) and high-voltage line 10L(+).

One terminal (+) of charge relay 7e is connected to high-voltage line 7L(+). The other terminal (+) of charge relay 7e is connected to charger BC via high-voltage line 11L(+). One terminal (−) of charge relay 7e is connected to high-voltage line 7L(−). The other terminal (−) of charge relay 7e is connected to charger BC via high-voltage line 11L(−). MBMS 7a controls charge relay 7e based on the state of battery pack 6 such that charge relay 7e performs connection/disconnection between high-voltage line 7L(+) and high-voltage line 11L(+) as well as performs connection/disconnection between high-voltage line 7L(−) and high-voltage line 11L(−).

One terminal of installation relay 7f is connected to high-voltage line 7L(+). The other terminal of installation relay 7f is connected to installation 5 via high-voltage line 12L(+). High-voltage line 12L(−) is connected to installation 5. MBMS 7a controls installation relay 7f based on a control signal of vehicle control unit (VCU) 8 corresponding to the state of installation 5, or the like, such that installation relay 7f performs connection/disconnection between high-voltage line 7L(+) and high-voltage line 12L(+).

Vehicle control unit (VCU) 8 controls installation 5 based on information indicating the state of installation 5. VCU 8 judges the state of the EV and executes control such that the EV is maintained in the optimum state. Specifically, in a case where VCU 8 detects an abnormality in the EV, VCU 8 controls motor 3 such that the EV stops. Further, VCU 8 controls supply power from battery pack 6 to motor 3 by changing the voltage between battery pack 6 and motor 3. Further, VCU 8 controls supply power from battery pack 6 to heater 4 by changing the voltage between battery pack 6 and heater 4. Further, VCU 8 controls charger BC such that the charging power when battery pack 6 is charged does not exceed the chargeable power.

As described above, MBMS 7a transmits each control signal of battery relay(+) 6b and battery relay(−) 6c to PBMS 6d based on the state of battery pack 6 (for example, cell temperatures, cell voltages, and SOCs). According to the control signals of MBMS 7a, PBMS 6d controls battery relay(+) 6b such that battery relay(+) 6b performs connection/disconnection between high-pressure line 6L(+) and high-pressure line 7L(+) and controls battery relay(−) 6c such that battery relay(−) 6c performs connection/disconnection between high-pressure line 6L(−) and high-pressure line 7L(−). High-voltage line 6L(+) and high-voltage line 7L(+) are connected and high-voltage line 6L(−) and high-voltage line 7L(−) are connected, and thus, battery pack 6 becomes battery pack 6 as an object to be connected which is connected to external load 2 or charger BC.

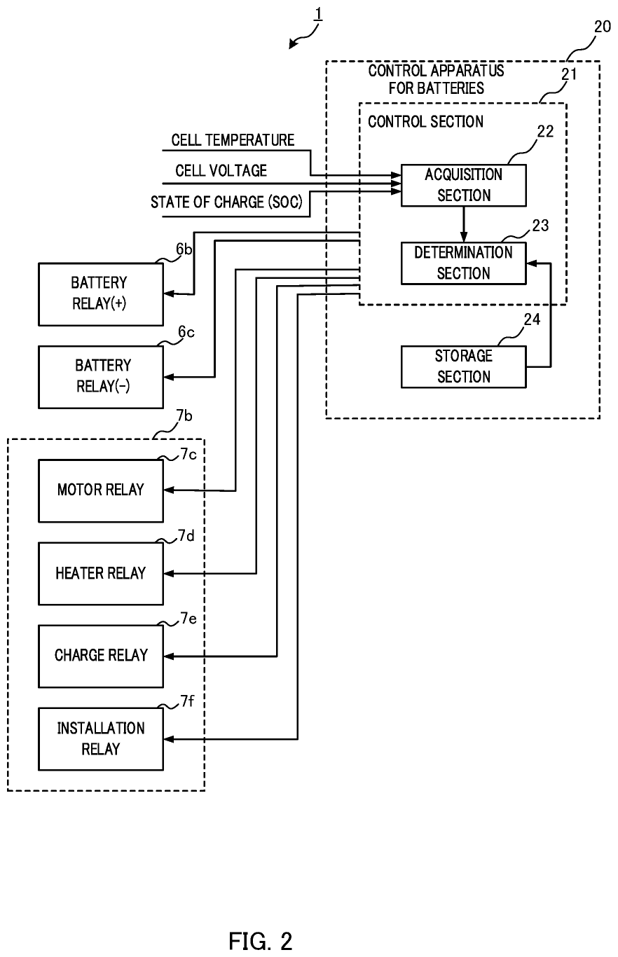

Next, a specific example of electric power system 1 will be described with reference to FIG. 2. FIG. 2 functionally illustrates an example of a control apparatus in the electric power system. In the present embodiment, it is assumed that the control apparatus is included in vehicle control unit 8. Note that, control apparatus 20 may be provided as an apparatus separate from vehicle control unit 8 in the vehicle.

Control apparatus 20 monitors the state of battery pack 6 such as voltages, currents, temperatures, and states of charge (SOCs) in battery pack 6 as well as performs control for safe and efficient use of battery pack 6.

Control apparatus 20 includes control section 21 and storage section 24. In FIG. 2, the arrows indicate main data flows, and there may be a data flow(s) not illustrated in FIG. 2. In FIG. 2, each functional block does not indicate a structure of hardware (apparatus) units, but a structure of functional units. For this reason, the functional blocks illustrated in FIG. 2 may be implemented within a single apparatus, or may be implemented separately in a plurality of apparatuses. Transfer of data between functional blocks may be performed via an arbitrary means such as a data bus, a controller area network (CAN bus), or the like.

Storage section 24 is a storage apparatus such as a read only memory (ROM) which stores a basic input output system (BIOS) or the like of a computer realizing control apparatus 20, a random access memory (RAM) which becomes a workspace for control apparatus 20, an operating system (OS), an application program, and a hard disk drive (HDD) and a solid state drive (SSD) which store various information to be referred to when the application program is executed.

Control section 21 is a processor such as a central processing unit (CPU) and a graphics processing unit (GPU) of control apparatus 20, and functions as acquisition section 22 and determination section 23 by executing a program stored in storage section 24.

Note that, FIG. 2 illustrates an example when control apparatus 20 is formed of a single apparatus. Having said that, control apparatus 20 may be implemented by computational resources such as, for example, a plurality of processors or memories. In this case, each section forming control section 21 is implemented by at least one of a plurality of different processors executing a program. Note that, in a case where control apparatus 20 is formed of a single apparatus, for example, control apparatus 20 may be formed of all of battery pack management system (PBMS) 6d, master battery management system (MBMS) 7a, and vehicle control unit (VCU) 8 that are illustrated in FIG. 1. In a case where control apparatus 20 is formed of a plurality of apparatuses, for example, control apparatus 20 may be formed of PBMS 6d, MBMS 7a, and VCU 8 individually, or may be formed of a combination of two apparatuses among PBMS 6d, MBMS 7a, and VCU 8, and the other apparatus.

Acquisition section 22 acquires data indicating the states of a plurality of battery packs 6 including cell temperatures, cell voltages, and states of charge (SOCs) from respective PBMSs 6d (see FIG. 1) of the plurality of battery packs 6. The data acquired by acquisition section 22 is stored in storage section 24.

Determination section 23 determines whether each SOC in a plurality of battery packs 6 is equal to or less than a predetermined threshold. The predetermined threshold is a numerical value that is set in view of estimated errors in SOCs, for example, 7.2%.

Further, determination section 23 determines whether the mode is a drive mode or a charge mode. Note that, vehicles include those which have a plurality of drive modes and a plurality of charge modes. For example, the plurality of drive modes includes an eco-mode that makes the driving force of the motor with respect to the accelerator operation moderate. Here, for clarity of description, a description will be given on the assumption that there are one drive mode and one charge mode.

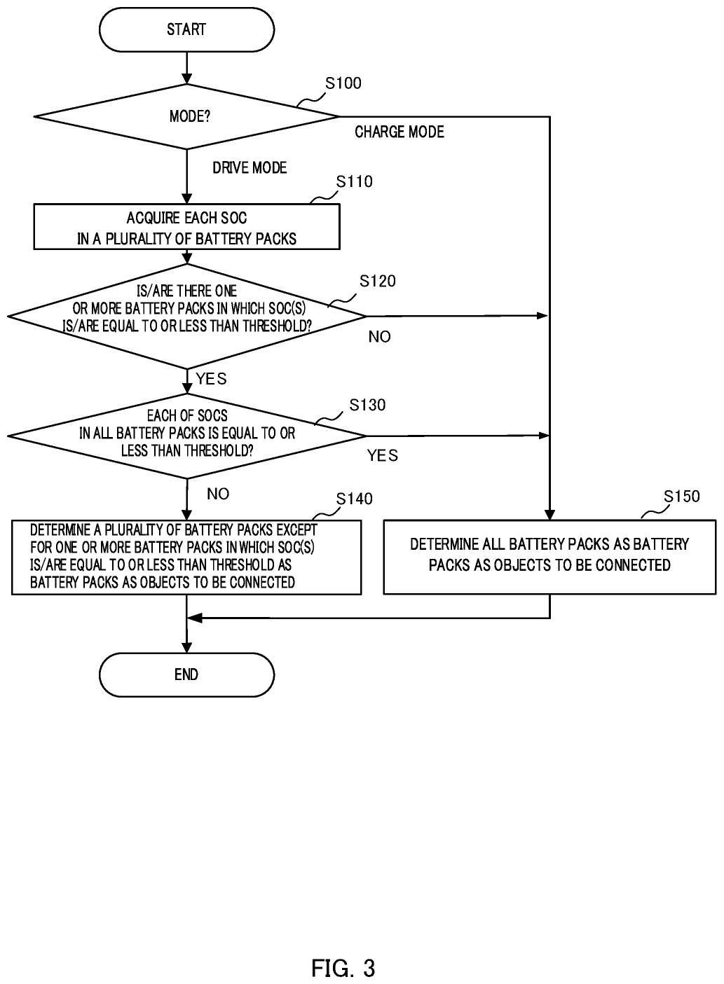

Next, an exemplary operation of control apparatus 20 in the present embodiment will be described with reference to FIG. 3. FIG. 3 is a flowchart illustrating an exemplary operation of control apparatus 20 in the present embodiment. This flowchart is started in a case where the EV is activated or in a case where the mode is changed. In the following description, a description will be given on the assumption that control section 21 (CPU) executes each function of control apparatus 20. In addition, in the following description, the “object to be connected” refers to an object that is connected to the load or the charger. Further, a battery pack to be connected to the load, which is mainly discharged to the load at the time of the operation of the vehicle to operate the load, will be referred to as a battery pack to be discharged. A battery pack that is connected to a charger at the time of charging the vehicle and is charged using the power received from the charger will be referred to as a battery pack to be charged.

First, in step S100, the CPU determines whether the mode is the drive mode or the charge mode. In a case where the mode is the drive mode (step S100: DRIVE MODE), the processing transitions to step S110. In a case where the mode is the charge mode (step S100: CHARGE MODE), the processing transitions to step S150.

Next, in step S110, the CPU acquires each SOC in a plurality of battery packs.

Next, in step S120, the CPU determines whether there are one or more low-remaining-amount battery packs among the plurality of battery packs. In a case where there are one or more low-remaining-amount battery packs (step S120: YES), the processing transitions to step S130. In a case where there is no low-remaining-amount battery pack (step S120: NO), the processing transitions to step S150.

Next, in step S130, the CPU determines whether each of the SOCs in all battery packs of the plurality of battery packs is equal to or less than the predetermined threshold. In a case where each of the SOCs in the all battery packs of the plurality of battery packs is equal to or less than the predetermined threshold (step S130: YES), the processing transitions to step S150. In a case where the SOCs in one battery pack or some battery packs among the plurality of battery packs are equal to or less than the predetermined threshold (step S130: NO), the processing transitions to step S140.

Next, in step S140, the CPU executes control such that battery packs other than the one or more low-remaining-amount battery packs are determined as battery packs as objects to be connected (battery packs to be discharged). Note that, the CPU may determine, among the battery packs other than the one or more low-remaining-amount battery packs, a battery pack(s) that further satisfies/satisfy a predetermined condition(s) as a battery pack(s) to be discharged. As the predetermined conditions(s), it is possible to set, for example, that a difference in the state of charge between the battery packs other than the one or more low-remaining-amount battery packs is equal to or less than a threshold, or the like.

Next, in step S150, the CPU executes control such that all battery packs are determined as battery packs as objects to be connected (battery packs to be charged). Note that, the CPU may determine that among the all battery packs, a battery pack(s) that further satisfies/satisfy a predetermined condition(s) as a battery pack(s) to be charged. As the predetermined conditions(s), it is possible to set, for example, that a difference in the state of charge between all the battery packs is equal to or less than a threshold, or the like.

Control apparatus 20 according to the embodiment described above is a control apparatus for a plurality of battery packs 6 which is included in a vehicle and is connected in parallel. Control apparatus 20 includes: acquisition section 22 that acquires each state of charge of the plurality of battery packs 6; and control section 21 that determines, among the plurality of battery packs 6, one or more battery packs 6 to be discharged and one or more battery packs 6 to be charged, where one or more battery packs 6 to be discharged supply power to external load 2 for driving the vehicle and one or more battery packs 6 to be charged are charged by an external power supply provided outside the vehicle. Control section 21 determines one or more battery packs 6 to be discharged from the plurality of battery packs 6 except for low-remaining-amount battery pack 6 which is, among the plurality of battery packs 6, battery pack 6 in which the state of charge is equal to or less than a predetermined threshold, and determines one or more battery packs 6 to be charged from the plurality of battery packs 6 including low-remaining-amount battery pack 6.

With the configuration described above, it is determined that battery pack 6 in which a SOC is equal to or less than the predetermined threshold is not battery pack 6 as an object to be connected, which is connected to external load 2, it is possible to cause battery pack 6 with a low SOC not to be discharged at or more than a design value.

Note that, in control apparatus 20 according to the embodiment described above, in a case where each of the SOCs in all battery packs 6 of the plurality of battery packs 6 is equal to or less than the predetermined threshold, control section 21 may execute control such that all battery packs 6 are determined as battery packs 6 as objects to be connected, where the objects to be connected are connected to external load 2. Thus, since it is possible to transmit to VCU 8 that each of the SOCs in all battery packs 6 is equal to or less than the predetermined threshold, VCU 8 can determine whether a defect occurs in battery packs 6 or whether an insufficient SOC occurs. As a result, it is possible to notify the user of a state of insufficient power.

Further, control apparatus 20 in the embodiment described above may further include a detection section that detects states (voltages, currents, temperatures, and SOCs) of the plurality of battery packs 6, and VCU 8 may control an operation of the EV according to a detection result of the detection section. Thus, for example, VCU 8 can inform the user of a detection result of the detection section, and of an operation of the EV, which corresponds to the detection result.

Further, in control apparatus 20 in the embodiment described above, in a case where each of the SOCs in all battery packs 6 of the plurality of battery packs 6 is equal to or less than the predetermined threshold, VCU 8 executes control such that it is notified that the EV is incapable of traveling. Thus, it is possible to urge the user to operate to stop the travel of the EV.

In addition, any of the embodiment described above is only illustration of an exemplary embodiment for implementing the present disclosure, and the technical scope of the present disclosure shall not be construed limitedly thereby. That is, the present disclosure can be implemented in various forms without departing from the gist or the main features thereof.

### INDUSTRIAL APPLICABILITY

The present disclosure is suitably utilized in a vehicle including a control apparatus required to cause a battery with a low SOC among a plurality of batteries connected in parallel not to be discharged at or more than a design value.

1. A control apparatus for a plurality of batteries included in a vehicle, the plurality of batteries being connected in parallel, the control apparatus comprising:
an acquisition section that acquires each state of charge of the plurality of batteries; and
a control section that determines, among the plurality of batteries, one or more batteries to be discharged and one or more batteries to be charged, the one or more batteries to be discharged supplying power to an external load for driving the vehicle, the one or more batteries to be charged being charged by an external power supply provided outside the vehicle, wherein
the control section determines the one or more batteries to be discharged from the plurality of batteries except for a low-remaining-amount battery, and determines the one or more batteries to be charged from the plurality of batteries including the low-remaining-amount battery, the low-remaining-amount battery being, among the plurality of batteries, a battery in which the state of charge is equal to or less than a predetermined threshold.

2. The control apparatus according to claim 1, wherein in a case where each of the states of charge in all batteries of the plurality of batteries is equal to or less than the predetermined threshold, the control section executes control such that the all batteries are determined as batteries as objects to be connected, the objects to be connected being connected to the external load.

3. The control apparatus according to claim 1, further comprising a detection section that detects states of the plurality of batteries, wherein
the control section controls an operation of the vehicle according to a detection result of the detection section.

4. The control apparatus according to claim 3, wherein in a case where each of the states of charge in the all batteries of the plurality of batteries is equal to or less than the predetermined threshold, the control section executes control such that it is notified that the vehicle is incapable of traveling.

5. A vehicle, comprising:
the control apparatus according to claim 1; and
the plurality of batteries.
